(19) United States
(12) Patent Application Publication
(10) Pub. No.: US 2026/0246334 A1
(43) Pub. Date: Aug. 20, 2026

(54) A ROTOR ASSEMBLY

(71) Applicant: Dyson Technology Limited, Malmesbury, Wiltshire (GB)

(72) Inventors: Alexander John ASBRIDGE, Bristol (GB); Thomas Edward HALHEAD, Bristol (GB); Harry Alexander MORLEY, Bristol (GB)

(21) Appl. No.: 19/143,088

(22) PCT Filed: Jan. 26, 2024
(86) PCT No.: PCT/IB2024/050740

§ 371 Date: Jun. 25, 2025

(30) Foreign Application Priority Data
Jan. 27, 2023 (GB) 2301187.7

(51) Int. Cl. H02K 7/00; A45D 20/10; A47L 5/28; H02K 1/2733; H02K 7/08; H02K 15/035

(52) U.S. Cl. CPC H02K 7/003; A45D 20/10; A47L 5/28; H02K 1/2733; H02K 7/083; H02K 15/035

(57) ABSTRACT

A rotor assembly for a brushless permanent magnet motor includes a shaft having a first portion having a first diameter, a second portion having a second diameter, and a third portion having a third diameter. The rotor assembly includes a first bearing assembly mounted to the first portion of the shaft, a permanent magnet mounted to the second portion of the shaft, and a second bearing assembly mounted to the third portion of the shaft. The second portion is located intermediate the first portion and the third portion, the second diameter is less than the first diameter, and the third diameter is less than the first and second diameters.

### FIELD OF THE INVENTION

The present invention relates to a rotor assembly for a brushless permanent magnet motor, and a brushless permanent magnet motor comprising such a rotor assembly.

### BACKGROUND OF THE INVENTION

There is a general desire to improve electric machines, such as brushless motors, in a number of ways. For example, improvements may be desired in terms of size, weight, power density, manufacturing cost, efficiency, reliability, and noise.

### SUMMARY OF THE INVENTION

According to a first aspect of the present invention there is provided a rotor assembly for a brushless permanent magnet motor, the rotor assembly comprising: a shaft comprising a first portion having a first diameter, a second portion having a second diameter, and a third portion having a third diameter; a first bearing assembly mounted to the first portion of the shaft; a permanent magnet mounted to the second portion of the shaft; and a second bearing assembly mounted to the third portion of the shaft; wherein the second portion is located intermediate the first portion and the third portion, the second diameter is less than the first diameter, and the third diameter is less than the first and second diameters.

The rotor assembly according to the first aspect of the present invention may effectively decouple an inner diameter of the permanent magnet from the inner diameters of the first and second bearing assemblies, as well as decoupling the inner diameters of the first and second bearing assemblies from one another, thereby enabling greater flexibility compared to, for example, a shaft having a constant diameter along its length, which would require the permanent magnet and the first and second bearing assemblies to have a substantially similar inner diameter. In other words, in the rotor assembly of the present invention, an inner diameter of the permanent magnet may be specified independently of the inner diameters of the first and second bearing assemblies, and the inner diameters of the bearing assemblies may be specified independently of one another.

It may be desirable, for example, to provide a relatively large bearing assembly at one end of the shaft to provide appropriate loading of the rotor assembly. If, however, an inner diameter of the permanent magnet is required to be the same as an inner diameter of such a relatively large bearing assembly, then an increase in packaging volume, either radially or axially, for the permanent magnet may be required to achieve the same volume of magnetic material in comparison to use of a shaft with a lower diameter portion to which the permanent magnet is mounted, as in the case of the present invention. Thus, the rotor assembly of the present invention may allow for decrease in packaging volume of the permanent magnet, whilst also providing the same volume of magnetic material.

Use of such a first relatively large bearing assembly, for example as the first bearing assembly of the rotor assembly, may enable use of a second relatively small bearing assembly, for example as the second bearing assembly of the rotor assembly. If a shaft with two diameters were utilised, one to accommodate the relatively large bearing assembly, and one to accommodate the relatively small bearing assembly, then the permanent magnet would need to comprise an inner diameter corresponding to either of those diameters. This may place constraints on diameters of the bearing assemblies to accommodate sufficient magnetic material for the permanent magnet, in the manner previously described. The rotor assembly of the first aspect of the present invention may mitigate for such factors.

Furthermore, the rotor assembly according to the first aspect of the present invention may provide improved rotor dynamics, for example a frequency response of the rotor assembly, compared to, for example, a similar rotor assembly having a shaft of constant diameter. For example, it may be desirable for critical operating modes of the rotor assembly to occur outside of a speed range in which a brushless permanent magnet motor comprising the rotor assembly is intended to operate in normal use. A frequency response of the rotor assembly can be dependent on a stiffness of the shaft. Thus, for a shaft of constant diameter, options for modifying the stiffness of the shaft to vary a frequency response may be limited. Use of exotic shaft materials, such as ceramic materials, has previously been proposed as a means to vary the frequency response to shift critical operating modes outside of the speed range in which a brushless permanent magnet motor comprising the rotor assembly is intended to operate in normal use. However, such exotic materials can be expensive, and difficult to manufacture and/or machine to a desired size.

By providing a shaft having portions of various diameters, the rotor assembly of the present invention may be utilised to provide a variation in stiffness that is sufficient to shift critical operating modes outside of the speed range in which a brushless permanent magnet motor comprising the rotor assembly is intended to operate in normal use, without the need to resort to exotic materials. This may reduce cost and/or complexity of a manufacturing process for the rotor assembly, whilst also ensuring appropriate frequency response.

The rotor assembly of the first aspect of the present invention may further enable use of relatively inexpensive manufacturing methods to form the shaft. For example, it may be desirable to provide a surface roughness to the shaft to facilitate mounting of the first and second bearing assemblies, and the permanent magnet, to the shaft. A shaft having three portions with differing diameters has been found to lend itself particularly well to a centreless precision grinding process, for example where both the first and third portions are precision ground at the same time, whilst a different surface roughness is applied to the second portion.

The second portion may comprise a different surface roughness to at least one, for example both, of the first and third portions. At least one of the first and third portions may comprise a surface roughness in the region of 0.1 to 0.3 Ra. The second portion may comprise a surface roughness in the region of 0.3 to 0.5 Ra.

The shaft may comprise a relative permeability in the region of 20 to 100, for example around 20. The shaft may comprise a ferromagnetic material, for example steel. The shaft may comprise stainless steel.

The first portion may comprise a first end of the shaft. The third portion may comprise a second end of the shaft opposite to the first end of the shaft.

The first diameter may be in the region of 1% to 20% greater than the second diameter, for example around 11% greater than the second diameter.

The first diameter may be in the region of 35% to 100% greater than the third diameter, for example around 66% greater than the third diameter.

The second diameter may be in the region of 10% to 75% greater than the third diameter, for example around 50% greater than the third diameter.

The first diameter may be in the region of 3.0 mm to 7.0 mm, for example around 5.0 mm. The second diameter may be in the region of 2.5 mm to 6.5 mm, for example around 4.5 mm. The third diameter may be in the region of 1.0 mm to 5.0 mm, for example around 3.0 mm.

A length of the first portion may be at least one of different to a length of the second portion and different to a length of the third portion. Varying the length of the portions in such a manner may enable increased flexibility in tailoring of rotor dynamics in the manner previously described, for example in comparison to a shaft of constant diameter, and/or in comparison to a shaft having portions of varying diameter but the same length. A length of the first portion may be at least one of greater than a length of the second portion and greater than a length of the third portion. This may facilitate mounting of more components on the first portion of the shaft, for example at one end of the shaft, in comparison to a second opposing end of the end.

A length of the first portion may be in the region of 10% to 75% greater than a length of the second portion. A length of the first portion may be in the region of 25% to 200% greater than a length of the third portion. Varying the length of the portions in such a manner may enable increased flexibility in tailoring of rotor dynamics in the manner previously described, for example in comparison to a shaft of constant diameter, and/or in comparison to a shaft having portions of varying diameter but the same length. A length of the second portion may be greater than a length of the third portion. This may maximise an amount of shaft to which the permanent magnet may be mounted for a given shaft length and given length of the first portion.

A length of the second portion may be in the region of 10% to 75% greater than a length of the third portion.

The shaft may comprise a total length in the region of 25 mm to 75 mm, for example around 50 mm. The first portion may comprise a length in the region of 15 mm to 35 mm, for example in the region of 25 mm. The second portion may comprise a length in the region of 10 mm to 20 mm, for example in the region of 15 mm. The third portion may comprise a length in the region of 5 mm to 15 mm, for example in the region of 10 mm.

The permanent magnet may comprise a length at least as long as a length of the second portion. The permanent magnet may comprise a length in the region of 10 mm to 22 mm, for example in the region of 8 mm.

A distance between the first and second bearing assemblies, for example a stride between centre points of the first and second bearing assemblies, may be in the region of 15 mm to 45 mm, for example in the region of 30 mm.

The shaft may comprise a transition region intermediate the first and second portions, the transition region comprising a fourth diameter less than the first and second diameters. Such a transition region may facilitate manufacture of the rotor assembly, for example by providing ease of access to a channel between the permanent magnet and the second portion of the shaft during assembly, such that adhesive can be injected into the channel.

One or more of the first, second, and third portions, may comprise a tapered end. This may facilitate passing of components over the relevant portion of the shaft during assembly.

The rotor assembly may comprise an impeller mounted to the first portion, the impeller mounted further away from the second portion than the first bearing assembly. Mounting an impeller to the first portion of the shaft, for example at an end of the first portion of the shaft, which has the largest diameter, may enable a relatively large bearing to be located closest to the impeller, which may provide for improved rotor dynamics in comparison to a smaller bearing assembly being located closes to the impeller.

The shaft may comprise a fourth portion having a fourth diameter less than the first diameter, the first portion intermediate the fourth and second portions, and the rotor assembly may comprise an impeller mounted to the fourth portion. This may allow for greater flexibility for aerodynamic design of the impeller compared to, for example, an embodiment where the impeller and the first bearing assembly are mounted to a portion of the shaft having a constant diameter. For example, mounting the impeller to a shaft portion of lower diameter compared to the shaft portion to which the first bearing assembly is mounted may permit a smaller impeller hub diameter at an inlet of the impeller. This may lead to a greater change in mean radius from the inlet of the impeller to the outlet of the impeller, which may lead to a greater pressure rise.

Mounting the impeller to a shaft portion of lower diameter compared to the shaft portion to which the first bearing assembly is mounted may also reduce a mass of the shaft in the region of the impeller, which may lead to improved rotor dynamics, for example as a result of a lower mass cantilevered on an unsupported portion of the shaft.

The first bearing assembly may be larger than the second bearing assembly. For example, the first bearing assembly may comprise at least one of a larger outer diameter than the second bearing assembly, a larger inner diameter of the bearing assembly, and, where the first and second bearing assemblies comprise ball bearings, a larger ball size than the second bearing assembly.

The impeller may be directly mounted to the shaft, for example press-fit to the shaft.

The first and/or second bearing assembly may be directly mounted to the shaft. For example, at least one of the first and second bearing assemblies may be press-fit onto the respective first and third portion of the shaft. This may provide for improved rotor dynamics in comparison to, for example, a rotor assembly where bearing assemblies are indirectly mounted to the shaft with one or more intervening components therebetween.

The permanent magnet may be mounted to the shaft via an adhesive. This may reduce a risk of compromising structural integrity of the permanent magnet compared to, for example, a rotor assembly where a magnet is press-fit onto the shaft.

The permanent magnet may comprise an outer diameter substantially corresponding to an outer diameter of the second bearing assembly. This may facilitate insertion of the rotor assembly into a relevant housing of a brushless permanent magnet motor.

The permanent magnet may comprise a two-pole permanent magnet.

The rotor assembly may comprise at least one balance ring, for example a balance ring mounted to the first portion between the first bearing assembly and the permanent magnet, and/or a balance ring mounted to the third portion between the second bearing assembly and the permanent magnet. Such balance rings may enable improved rotor dynamics, for example in comparison to a rotor assembly absent such balance rings.

According to a second aspect of the present invention there is provided a brushless permanent magnet motor comprising a rotor assembly according to the first aspect of the present invention.

The brushless permanent magnet motor may comprise a stator assembly comprising one or more coils which, when energised, generate a magnetic field that interacts with the permanent magnet to rotate the shaft relative to the stator assembly.

According to a third aspect of the present invention there is provided a vacuum cleaner comprising a brushless permanent magnet motor according to the second aspect of the present invention.

According to a fourth aspect of the present invention there is provided a haircare appliance comprising a brushless permanent magnet motor according to the second aspect of the present invention.

According to a fifth aspect of the present invention there is provided a shaft for a rotor assembly of a brushless permanent magnet motor, the shaft comprising a first portion having a first diameter, a second portion having a second diameter different to the first diameter, and a third portion having a third diameter different to the first and second diameters, wherein the second portion is located intermediate the first portion and the third portion, the second diameter is less than the first diameter, and the third diameter is less than the first and second diameters.

Optional features of aspects of the present invention may be equally applied to other aspects of the present invention, where appropriate.

### BRIEF DESCRIPTION OF THE DRAWINGS

FIG. 1 is a schematic cross-sectional view of a rotor assembly;

FIG. 2 is a schematic cross-sectional view of a shaft of the rotor assembly of FIG. 1;

FIG. 3 is a schematic perspective view of a first balance ring of the rotor assembly of FIG. 1;

FIG. 4 is a flow diagram illustrating assembly steps of the rotor assembly of FIG. 1;

FIG. 5 is a schematic illustration of a brushless permanent magnet motor comprising the rotor assembly of FIG. 1;

FIG. 6 is a schematic illustration of a vacuum cleaner comprising the brushless permanent magnet motor of FIG. 5;

FIG. 7 is a schematic illustration of a haircare appliance comprising the brushless permanent magnet motor of FIG. 1;

FIG. 8 is a schematic illustration of an alternative shaft and balance ring for the rotor assembly of FIG. 1;

FIG. 9 is a schematic illustration of an alternative shaft and impeller for the rotor assembly of FIG. 1.

### DETAILED DESCRIPTION OF THE INVENTION

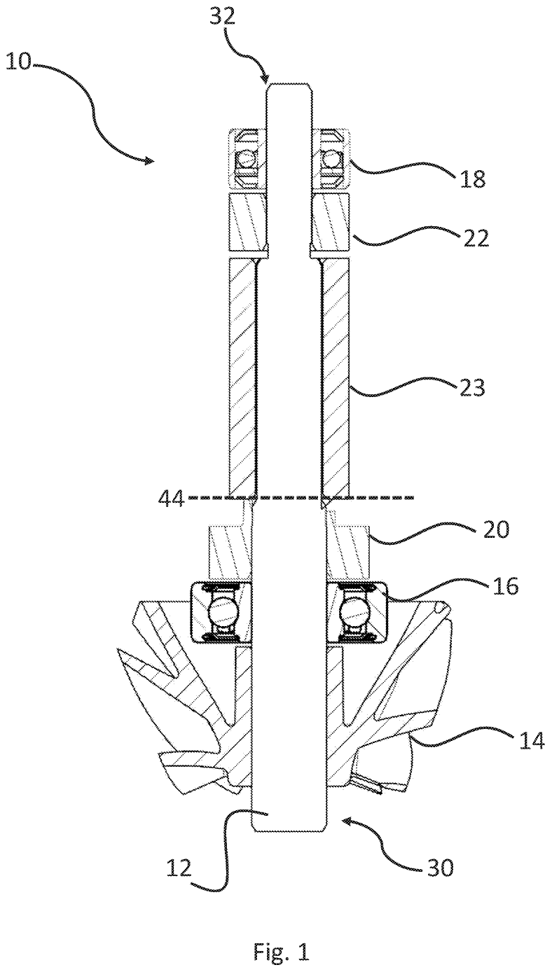

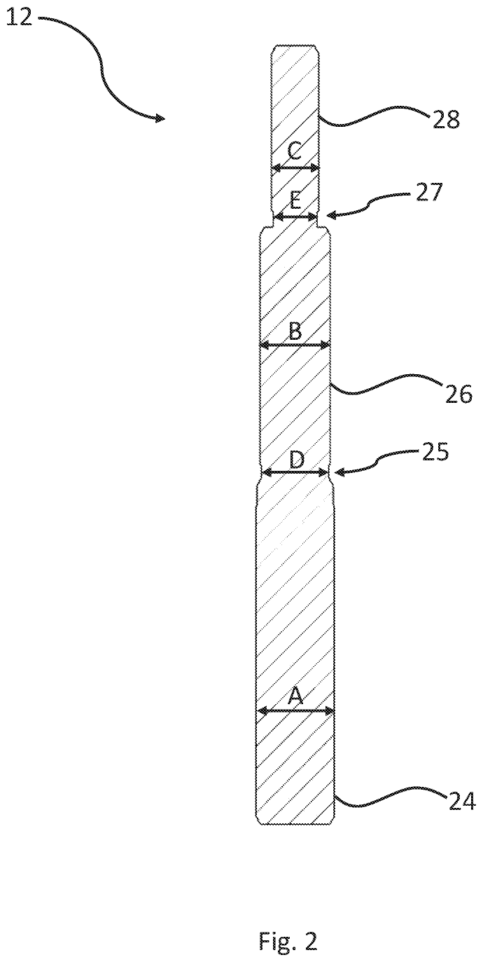

A rotor assembly 10 is illustrated schematically in FIG. 1. The rotor assembly 10 comprises a shaft 12, an impeller 14, first 16 and second 18 bearing assemblies, first 20 and second 22 balance rings, and a permanent magnet 23. The shaft 12 is illustrated in isolation in the schematic cross-section of FIG. 2. The shaft 12 comprises a first portion 24, a second portion 26 adjacent to the first portion 24, a first transition region 25 between the first 24 and second 26 portions, a third portion 28 adjacent to the second portion 26, and a second transition region 27 between the second 26 and third 28 portions. In such a manner the second portion 26 is considered to be intermediate the first 24 and third 28 portions. The first portion 24 defines a first end 30 of the shaft 12, and the third portion 28 defines a second end 32 of the shaft 12 opposite to the first end 30. The shaft is a monolithic stainless steel component, such that the first 24, second 26 and third 28 portions are integrally formed. The shaft 12 has a relative magnetic permeability of around 20. In some alternative examples, the first 25 and/or second 27 transition regions may be omitted.

The first portion 24 has a first shaft diameter A in the region of 5.0 mm, and a length in the region of 25 mm. The first shaft diameter A defines a maximal diameter of the shaft 12. Ends of the first portion 24 are tapered inwardly slightly from the first shaft diameter A. The second portion 26 has a second shaft diameter B in the region of 4.5 mm, and a length in the region of 15 mm. An end of the second portion 26 closest to the third portion 28 is tapered inwardly slightly from the second shaft diameter B. The third portion 28 has a third shaft diameter C in the region of 3.0 mm, and a length in the region of 10 mm. An end of the third portion 28 distal from the second portion 26 is tapered slightly inwardly from the third shaft diameter C. The first transition region 25 has a fourth shaft diameter D which is smaller than the first A and second B shaft diameters, but greater than the third shaft diameter C. The second transition region 27 has a fifth shaft diameter E which is smaller than the third shaft diameter C.

Thus the first portion 24 has a first shaft diameter A greater than the second shaft diameter B of the second portion 26, and greater than the third shaft diameter C of the third portion 28. In particular, the first shaft diameter A is around 11% greater than the second shaft diameter B, and around 66% greater than the third shaft diameter C. The second shaft diameter B is around 50% greater than the third shaft diameter C.

The first portion 24 has a length around 66% greater than the length of the second portion 26, and a length around 150% greater than the length of the third portion 28. The second portion 26 has a length around 50% greater than the length of the third portion 28.

The first 24 and second 28 portions of the shaft 12 are precision ground, with a surface roughness in the region of 0.1 to 0.3 Ra. The second portion 26 of the shaft 12 is precision ground to a surface roughness greater than that of the first 24 and second 28 portions of the shaft 12, with a surface roughness typically in the region of 0.3 to 0.5 Ra.

The impeller 14 is a mixed flow impeller and is press-fit to the first portion 24 such that the impeller 14 is located at the first end 30 of the shaft 12. Axial and/or radial flow impellers are also envisaged. The impeller 14 is injection moulded using a PEEK material.

The first bearing assembly 16 comprises a ball bearing assembly, and is press-fit to the first portion 24 of the shaft 12 such that the first bearing assembly 16 lies partly within a hollow interior of the impeller 14. The first bearing assembly 14 thereby has an inner diameter substantially corresponding to the first shaft diameter A. The first bearing assembly 16 has an outer diameter greater than outer diameters of each of the second bearing assembly 18, the first 20 and second 22 balance rings, and the permanent magnet 23.

The second bearing assembly 18 comprises a ball bearing assembly, and is press-fit to the third portion 28 of the shaft 12 such that the second bearing assembly 18 is located at the second end 32 of the shaft 12. The second bearing assembly 18 thereby has an inner diameter substantially corresponding to the third shaft diameter C. The second bearing assembly 18 has an outer diameter substantially corresponding to outer diameters of the second balance ring 22 and the permanent magnet 23, but smaller than an outer diameter of the first balance ring 20.

The first 16 and second 18 bearing assemblies are located at points on the respective first 24 and third 28 portions of the shaft 12 such that the stride between the first 16 and second 18 bearing assemblies is around 30 mm.

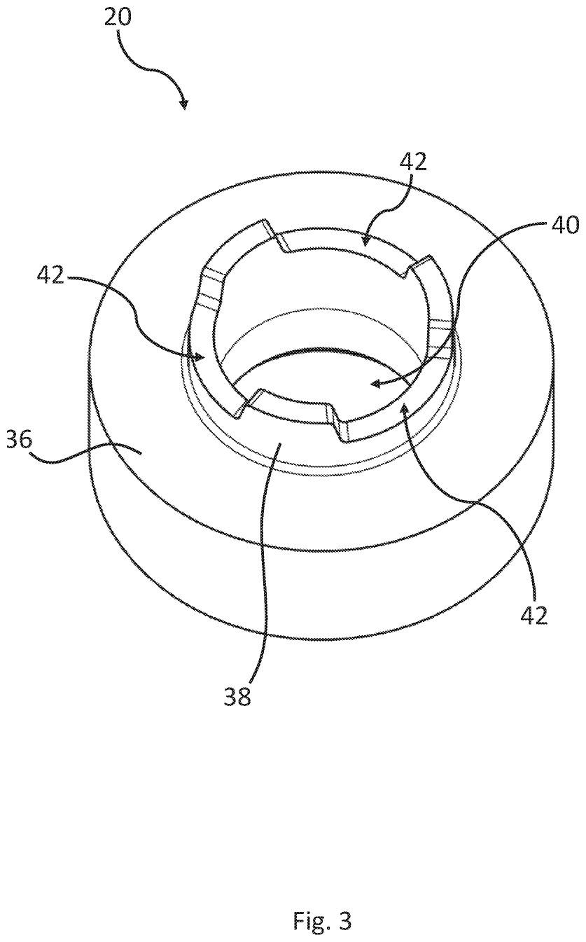

The first balance ring 20 is shown in isolation in FIG. 3. The first balance ring 20 has a base portion 36 and an upstanding wall 38. The base portion 36 is substantially annular and solid in form, with a central bore 40. The central bore 40 has a diameter substantially corresponding to the first shaft diameter A of the first portion 24 of the shaft 12, such that the first balance ring 20 is press-fit to the first portion 24 of the shaft 12 when assembled. The upstanding wall 38 is integrally formed with the base portion 36 from a plastics material such that the first balance ring 20 is a monolithic component. The upstanding wall 38 projects from the base portion 36 annularly about the central bore 40, and has three through-holes 42 evenly spaced about a periphery of the upstanding wall 38, which may also be referred to as cut-outs, such that the upstanding wall 38 has a generally castellated form. When mounted to the shaft 12, the through-holes 42 span the first portion 24 and the transition region 25 of the shaft 12.

The second balance ring 22 is substantially annular and solid in form, and is formed of a plastics material. The second balance ring 22 is press-fit to the third portion 28 of the shaft 12, with the second bearing assembly 18 located closer to the second end 32 of the shaft 12 than the second balance ring 22. The second balance ring 22 has a smaller mass than the first balance ring 20.

The permanent magnet 23 is a two-pole sintered magnet, and is mounted to the second portion 26 of the shaft 12 via an adhesive. When mounted to the second portion 26 of the shaft 12, the permanent magnet 23 is in contact with the upstanding wall 38 of the first balance ring 20 at an interface 44. The interface 44 is illustrated by a dashed line in FIG. 1.

To assemble the rotor assembly 10, the impeller 14 is initially press-fit onto the first portion 24 of the shaft 12. The first bearing assembly 16 is then also press-fit onto the first portion 24 of the shaft 12, with the first bearing assembly 16 inserted from the second end 32 of the shaft 12. The first balance ring 20 is then then also press-fit onto the first portion 24 of the shaft 12, with the first bearing assembly 16 inserted from the second end 32 of the shaft 12.

Subsequently, the permanent magnet 23 is bonded to the second portion 26 of the shaft 12 via an adhesive. It may be desirable for an inner diameter of the permanent magnet 23 to be as concentric with the shaft 12 as possible. Where adhesive is applied between the permanent magnet 23 and the shaft 12, such adhesive may be largely hidden by the permanent magnet 23. This may inhibit the use of certain types of curing process to cure the adhesive, for example ultra-violet (UV) curing processes, as there is no way to guarantee that all of the adhesive will be reached by UV light, and hence fully cure.

It may therefore be necessary to use alternative processes for curing the adhesive, such as, for example, heat curing processes. However, heat curing processes may take significantly longer than UV curing processes. This may result in a window in which the permanent magnet 23 is not securely held in position relative to the shaft 12, and in which misalignment of the permanent magnet relative to the shaft may occur. Correct alignment of the permanent magnet 23 and the shaft 12 may be important for reliable operation of a brushless permanent magnet motor comprising the rotor assembly 10.

The form of the first balance ring 20, and the contact of the first balance ring 20 and the permanent magnet 23 at the interface 44, may facilitate proper alignment of the permanent magnet 23 and the shaft 12 during manufacture of the rotor assembly 10. In particular, the permanent magnet 23 can be slid along the shaft 12 from the second end 32 of the shaft 12 until an end of the permanent magnet 12 contacts the upstanding wall 38 of the first balance ring 20. By placing the first balance ring 20 in contact with the permanent magnet 23 proper axial location of the permanent magnet 23 relative to the shaft 12 during an assembly process, may be achieved.

Furthermore, as the through-holes 42 are located at the interface 44 between the rotor assembly component and the permanent magnet, a line-of-sight path may be provided such that a relatively quick-curing UV curing process can be used to tack the permanent magnet 23 relative to the shaft 12 whilst a longer heat curing process is subsequently used to fully cure the adhesive to secure the permanent magnet 23 to the shaft 12. It will be appreciated that the through-holes 42 may be at least partially filled with adhesive, such as tacking adhesive, in the final assembled rotor assembly 10.

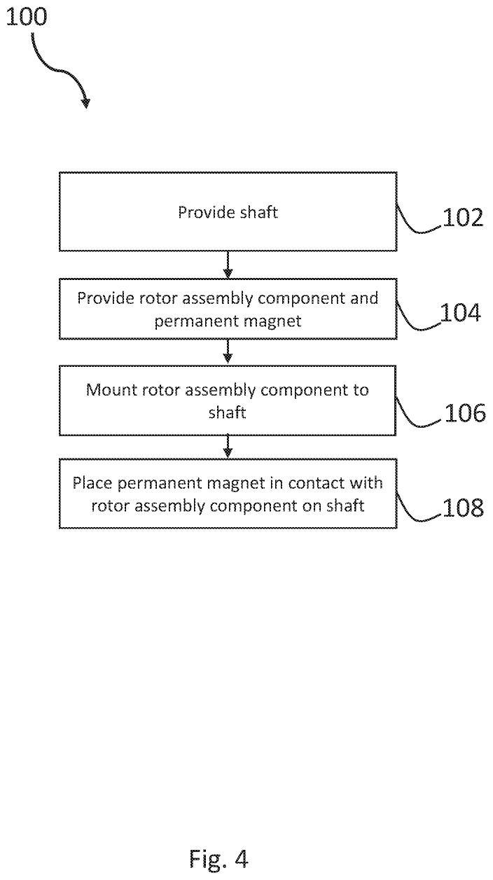

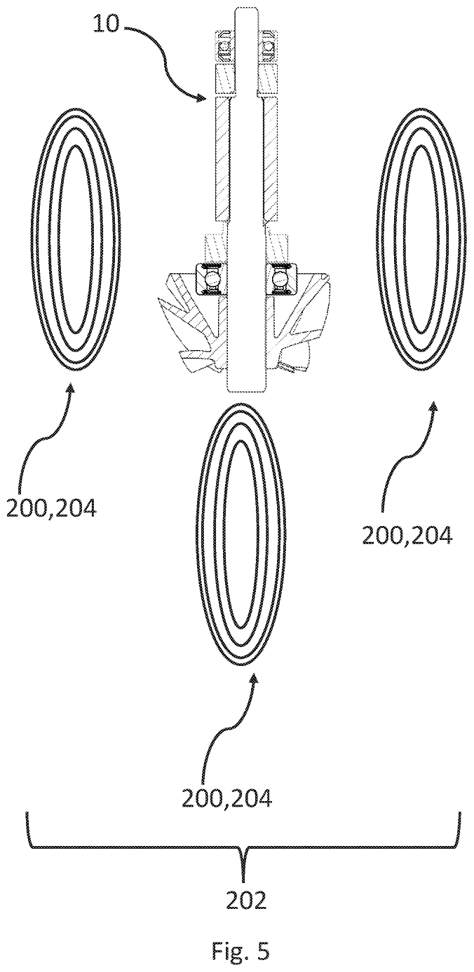

A method 100 in accordance with the above is illustrated in the flow diagram of FIG. 4.

The method 100 comprises providing 102 a shaft, and providing 104 a rotor assembly component and a permanent magnet, at least one of the rotor assembly component and the permanent magnet comprising a through-hole. The method comprises mounting 106 the rotor assembly component to the shaft; and placing 108 the permanent magnet relative to the shaft such that the permanent magnet is in contact with the rotor assembly component at an interface, and the through-hole is located at the interface.

It will be appreciated that the method 100 is described here more generally in relation to a rotor assembly component, and that other components, such as the first bearing assembly 16 or the impeller 14, or indeed the permanent magnet 23 itself, may be shaped to provide the through-holes, and that other components such as the first bearing assembly 16 or the impeller 14 may be placed in contact with the permanent magnet 23 to ensure proper axial alignment.

A further benefit associated with the rotor assembly 10 arises from the form of the shaft 12, and in particular the first portion 24 having the first shaft diameter A greater than the second shaft diameter B of the second portion 26, and greater than the third shaft diameter C of the third portion 28, and the second shaft diameter B being greater than the third shaft diameter C.

In particular, this may effectively decouple an inner diameter of the permanent magnet 23 from the inner diameters of the first 16 and second 18 bearing assemblies, as well as decoupling the inner diameters of the first 16 and second 18 bearing assemblies from one another, thereby enabling greater flexibility compared to, for example, a shaft having a constant diameter along its length, which would require the permanent magnet and the first and second bearing assemblies to have a substantially similar inner diameter. In other words, in the rotor assembly 10, an inner diameter of the permanent magnet 23 may be specified independently of the inner diameters of the first 16 and second 18 bearing assemblies, and the inner diameters of the bearing assemblies 16,18 may be specified independently of one another.

Although specific dimensions of the first 24, second 26, and third 28 portions of the shaft 12 have been illustrated in the specific example above, alternative shaft dimensions and ratios are also envisaged.

For example, the first shaft diameter A may be in the region of 1% to 20% greater than the second shaft diameter B, may be in the region of 35% to 100% greater than the third shaft diameter C, and may be in the region of 3.0 to 7.0 mm. The second shaft diameter B may be in the region of 10% to 75% greater than the third shaft diameter C, and may be in the region of 2.5 mm to 6.5 mm. The third shaft diameter C may be in the region of 1.0 mm to 5.0 mm.

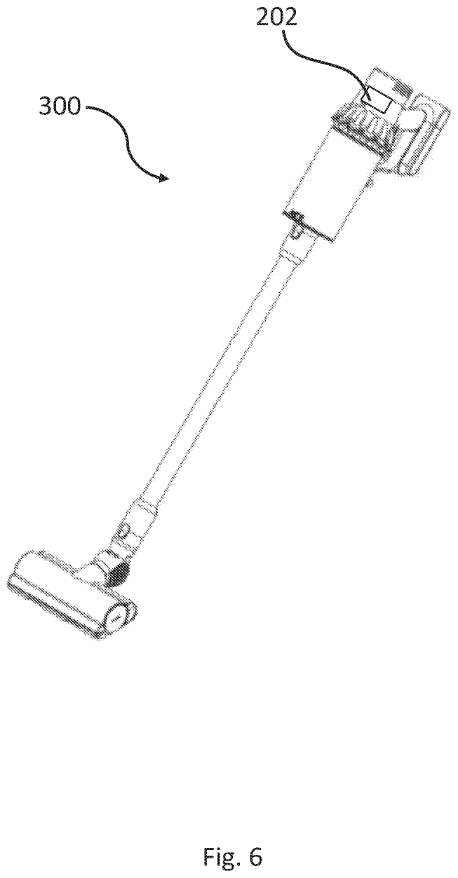

In use, the rotor assembly 10 is paired with a stator assembly 200 to form a brushless permanent magnet motor 202, as illustrated schematically in FIG. 6. The stator assembly 200 comprises three coils 204, and, when the three coils 204 are driven with an appropriate voltage, the stator assembly 200 generates a magnetic field that interacts with the permanent magnet 23 to rotate the rotor assembly 10.

A vacuum cleaner 300 comprising the brushless permanent magnet motor 202 is illustrated schematically in FIG. 6.

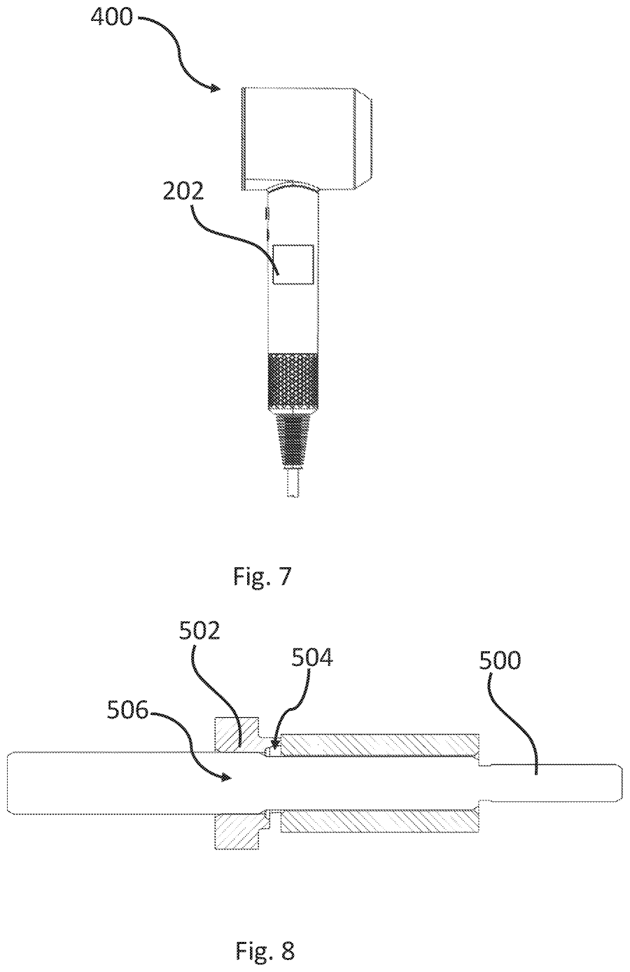

A haircare appliance 400 comprising the brushless permanent magnet motor 202 is illustrated schematically in FIG. 7.

An alternative shaft 500 and first balance ring 502 are shown schematically in FIG. 8, where like reference numerals are used for sake of clarity. The shaft 500 of FIG. 8 differs from the shaft 12 of FIGS. 1 and 2 in that the shaft 500 of FIG. 8 omits the first transition region 25. The first balance ring 502 of FIG. 8 has a bore with first 504 and second 506 regions of differing diameters. The first region 504 has a diameter larger than the diameter of the second region 506, and defines a region in which the adhesive used to bond the permanent magnet 23 to the shaft 500 can collect. Providing a region in which adhesive may collect may facilitate bonding of the adhesive to the first balance ring 502, which may inhibit adhesive from detaching from the first balance ring 502 when the rotor assembly spins in use.

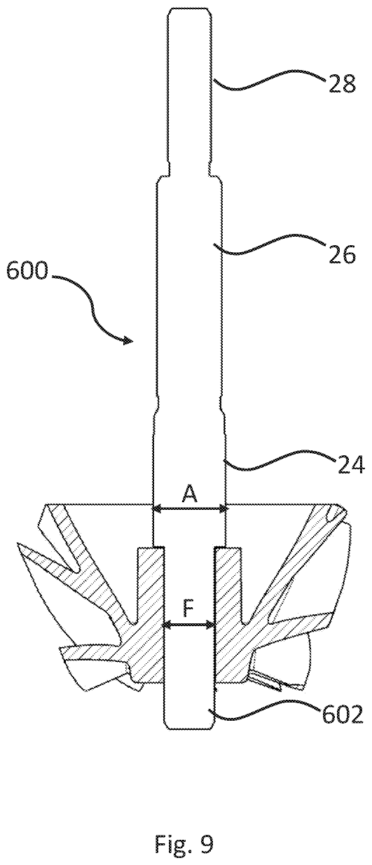

A further alternative shaft 600 and an impeller 14 are shown schematically in FIG. 9, where like reference numerals are used for sake of clarity. The shaft 600 of FIG. 9 differs from the shaft 12 of FIGS. 1 and 2 in that the shaft 600 of FIG. 9 has a fourth portion 602 having a sixth shaft diameter F that is less than the first shaft diameter A. The impeller 14 is mounted to the fourth portion 602. This may allow for greater flexibility for aerodynamic design of the impeller 14 compared to, for example, the embodiment of FIGS. 1 and 2.

It will be appreciated that other features of the rotor assembly 10 of FIGS. 1 and 2 may be utilised alongside the embodiments of FIGS. 8 and 9.

1. A rotor assembly for a brushless permanent magnet motor, the rotor assembly comprising:
a shaft comprising a first portion having a first diameter, a second portion having a second diameter, and a third portion having a third diameter;
a first bearing assembly mounted to the first portion of the shaft;
a permanent magnet mounted to the second portion of the shaft; and
a second bearing assembly mounted to the third portion of the shaft,
wherein the second portion is located intermediate the first portion and the third portion, the second diameter is less than the first diameter, and the third diameter is less than the first and second diameters.

2. The rotor assembly as claimed in claim 1, wherein the first diameter is in the region of 1% to 20% greater than the second diameter.

3. The rotor assembly as claimed in claim 1, wherein the first diameter is in the region of 35% to 100% greater than the third diameter.

4. The rotor assembly as claimed in claim 1, wherein the second diameter is in the region of 10% to 75% greater than the third diameter.

5. The rotor assembly as claimed claim 1, wherein a length of the first portion is at least one of different to a length of the second portion and/or different to a length of the third portion.

6. The rotor assembly as claimed in claim 1, wherein a length of the first portion is at least one of greater than a length of the second portion and/or greater than a length of the third portion.

7. The rotor assembly as claimed in claim 1, wherein a length of the first portion is in the region of 10% to 75% greater than a length of the second portion.

8. The rotor assembly as claimed in claim 1, wherein a length of the first portion is in the region of 25% to 200% greater than a length of the third portion.

9. The rotor assembly as claimed in claim 1, wherein a length of the second portion is different than a length of the third portion.

10. The rotor assembly as claimed in claim 1, wherein a length of the second portion is greater than a length of the third portion.

11. The rotor assembly as claimed in claim 1, wherein a length of the second portion is in the region of 10% to 75% greater than a length of the third portion.

12. The rotor assembly as claimed in claim 1, where the shaft comprises a transition region intermediate the first and second portions, the transition region comprising a fourth diameter less than the first and second diameters.

13. The rotor assembly as claimed in claim 1, wherein one or more of the first, second, and/or third portions comprises a tapered end.

14. The rotor assembly as claimed in claim 1, wherein:
the rotor assembly comprises an impeller mounted to the first portion; and
the impeller is mounted further away from the second portion than from the first bearing assembly.

15. The rotor assembly as claimed in claim 1, wherein:
the shaft comprises a fourth portion having a fourth diameter less than the first diameter;
the first portion is located intermediate the fourth and second portions; and
the rotor assembly comprises an impeller mounted to the fourth portion.

16. The rotor assembly as claimed in claim 1, wherein at least one of the first and/or second bearing assemblies is press-fit onto the respective first and/or third portion of the shaft.

17. The rotor assembly as claimed in claim 1, wherein the first bearing assembly is larger than the second bearing assembly.

18. The rotor assembly as claimed in claim 1, wherein the permanent magnet comprises an outer diameter substantially corresponding to an outer diameter of the second bearing assembly.

19. A The rotor assembly as claimed in any claim 1 in combination with a brushless permanent magnet motor.

20. The rotor assembly as claimed in claim 19 in combination with a vacuum cleaner.

21. The rotor assembly as claimed in claim 19 in combination with a haircare appliance.
